(19) United States
(12) Patent Application Publication
(10) Pub. No.: US 2015/0050845 A1
(43) Pub. Date: Feb. 19, 2015

(54) PLUG CONNECTOR WITH CONTACT DETENT MEANS

(71) Applicant: Amphenol Tuchel Electronics GmbH, Heilbronn (DE)

(72) Inventors: Jens Honnige, Heilbronn (DE); Michael Grimm, Mosbach (DE)

(21) Appl. No.: 14/380,449

(22) PCT Filed: Apr. 6, 2013
(86) PCT No.: PCT/EP2013/001022

§ 371 Date: Aug. 22, 2014

(30) Foreign Application Priority Data
Apr. 13, 2012 (DE) 10 2012 007 481.6

(51) Int. Cl. H01R 13/426

(52) U.S. Cl. CPC H01R 13/426
USPC 439/695

(57) ABSTRACT

The invention relates to a plug connector comprising a contact support with at least one or a plurality of contact chambers for accommodating a contact, at least one electrical contact, a lateral opening on each side of the contact support, each opening being connected to one of the contact chambers, and at least one locking element, which can be inserted into the opening in a clamping manner such that a locking section of the locking element stops or locks the contact in the contact chamber on a corresponding locking section.

The present invention relates to a plug connector with contact latching means according to claim 1.

In the prior art there are various principles for how contacts of an electrical plug connector are fastened in the contact body or contact support of the plug connector.

A common variant is the engagement of the contacts in a latching manner by means of one or more spring arms that are fastened directly to the contacts and are supported in equivalent corresponding clearances in the contact support or allow themselves to become latched there.

Such contacts are typically fitted once into the contact support and become permanently latched there, i.e. if it were attempted to release the contact from the contact support, the resilient latching arms would be bent or damaged.

Further solutions for releasably latching contacts in the contact support can be found in the prior art, solutions in which special tools are used to allow the contacts to be operated from the outside and arranged re-releasably in the contact support.

However, there is the problem with the plug connectors known from the prior art that, with increasing miniaturization of the plug connectors and the requirement for higher current carrying capacity, proven contact latching principles lead to large structural forms.

In particular, the air gaps and creepage distances for plug connectors must conform to IEC 61984 or IEC 60664-1 and be dimensioned appropriately in accordance with the application area. Under this premise, there are problems on the one hand in maintaining sufficient distance between the contacts but also on the other hand of making plug connectors sufficiently small.

It is therefore intended to prevent metallic contact latching arms or other latching principles of one contact with respect to the other contact from leading to great relative distances between the contacts.

In other words, an object of the present invention is to provide a simpler, more reliable and more favorable locking and latching of contacts in a contact support while maintaining the required air gaps and creepage distances.

This object is achieved by a plug connector with the features of claim 1.

The basic concept of the invention is to latch the contacts in the plug connector by means of a locking element, preferably a coded locking element, to be precise in such a way that the coding element can be inserted into the contact support from the outside, into a locking position intended for it, whereby the contact is fixed and latched in its intended mounting position by a locking portion of the locking element.

In an advantageous way, the following forms of design have been preferred here:
the contacts are preferably provided with a peripheral annular groove, into which the locking means can engage in order to fix the contacts on the contact support;
the contact support has openings, into which locking elements can be inserted into the contact chamber of the contact support in order to come into connection there, preferably in a positively engaging manner and possibly in a nonpositively engaging manner, with the contact at the previously mentioned peripheral groove;
also preferably, the openings in the contact support between the contact chambers and the outer shell of the contact support are formed in such a way that the locking elements are held in the openings in a clamping manner;
with preference, the locking elements have coding lugs or coding ribs, which can engage into corresponding coding grooves on the contact support, in order to ensure that the respectively correct locking element is inserted into the intended opening in the contact support, in order to fix the contact mounted there;
each locking element can only be pushed completely into the contact support and lock there if the contact is arranged at its intended position in the contact chamber, and so the locking elements also assume the function of ensuring that a correct contact position in the contact support is ensured;
in a further advantageous configuration, the locking elements allow themselves to be pushed completely into the contact support, and so they finish flush with the surface of the contact support, whereby it is ensured that the plug connector can only be inserted into a corresponding mating connector if the contacts and locking elements have been introduced correctly and completely. This provides a function that ensures that the contacts are held reliably by the locking elements and the locking elements have been inserted in their intended latching position.

Further configurations of the invention are provided by the subclaims.

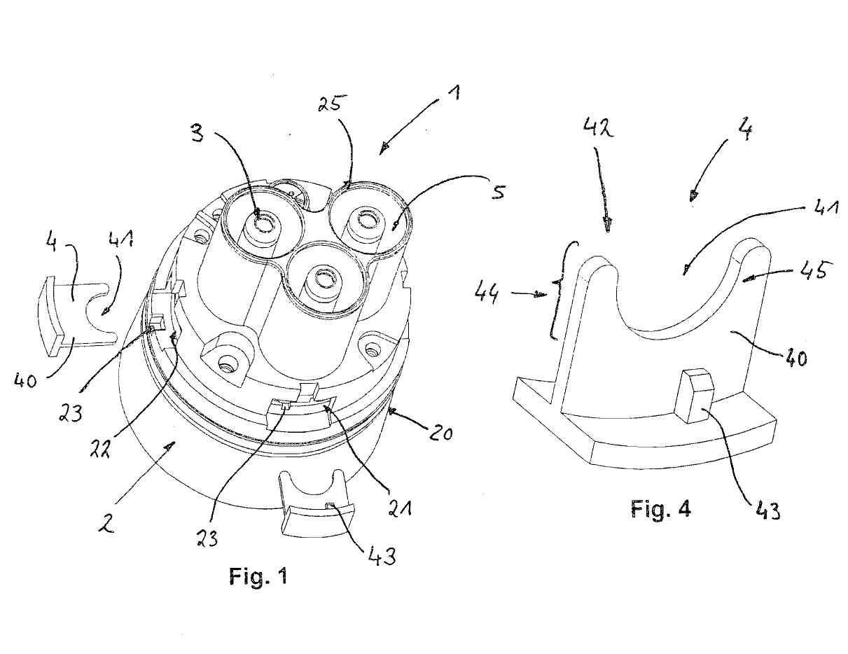

FIG. 1 shows a perspective view of the plug connector according to the invention;

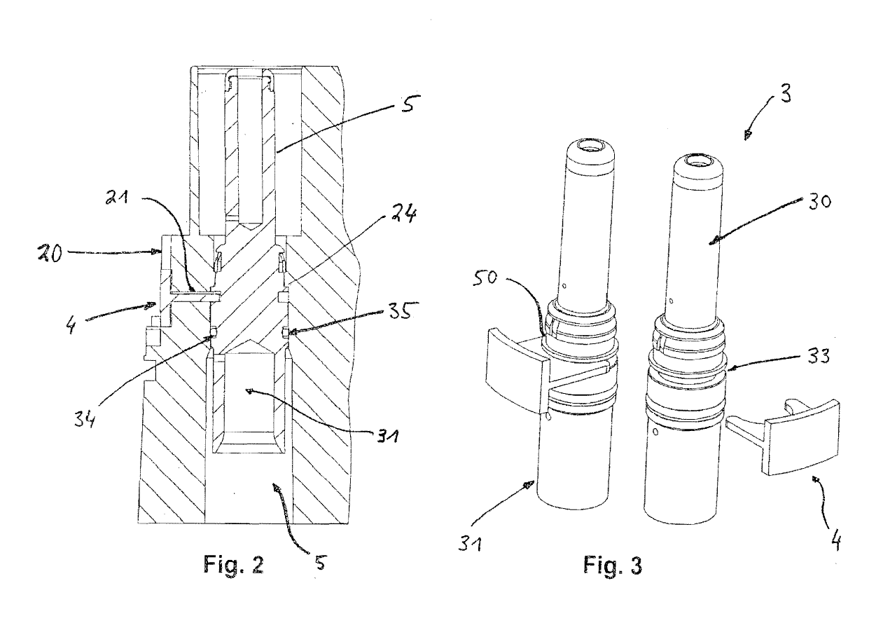

FIG. 2 shows a sectional view through a contact chamber of a plug connector according to the invention similar to the embodiment of FIG. 1;

FIG. 3 shows two contact elements or contacts, given by way of example, of the plug connector according to the invention in a perspective view with a locking element arranged in the latching state and a locking element at a distance from said contact element or contact;

FIG. 4 shows a locking element according to the present invention with a coding rib.

In FIG. 1, an electrical plug connector 1 according to an embodiment of the present invention that is given by way of example is shown.

The plug connector 1 is formed by a contact support 2, formed in which are contact chambers 5, into which contacts 3 have been introduced.

The contact support 2 is an insulating body, in which the contact chambers 5 are formed for receiving contacts 3 according to FIG. 3.

The contact support 2 has a contact support outer wall 20 and in the present exemplary embodiment is formed as a substantially cylindrical contact support for a round plug connector.

In the outer wall 20 there are openings 21, which are respectively assigned to a contact chamber 5 and, as can be seen in FIG. 1 and FIG. 2, have been introduced in clearances 22 in the contact support 2 or establish a connection with the contact chamber 5 from the outside.

The clearances 22 are preferably configured as window-like clearances, which have been introduced into the outer casing of the contact support 2 in a sunken manner.

This ensures that, when they are pushed into the contact support 2, to be precise into the openings 21, the locking elements 4 finish flush with the outer wall of the contact support 2, and so there are no troublesome outwardly protruding components.

The contact support 2 has abutting means 24, which interact with mating abutting means 50, to be precise contact abutting means 50 of a contact 3.

A contact 3 can be inserted into the contact support 2 from below in the view according to FIG. 2, to be precise into the contact chamber 5, until the contact abutting means 50 are abutting the corresponding abutting means 24.

As can be clearly seen in FIG. 2 and FIG. 3, in this position a peripheral latching groove 33 of the contact 3 is located in a plane together with the opening 21. The opening 21 is formed as a gap-like opening or a gap-like aperture, in order to push a locking element 4, in the position as described above, into the peripheral latching groove 33 with its plug-side end 42.

There follows a description of a locking element 4, shown in FIG. 4, which exhibits an embodiment of a locking element 4 according to the invention that is given by way of example.

The locking element 4 has a plate-like portion 40, at the plug-side end 42 of which there is a semicircular clearance 41.

It can also be seen that arranged on the locking element 9 is a coding rib 43, which ensures that the locking element 4 can only be inserted into its intended opening 21, which is provided on the contact support 2 and at which corresponding coding grooves 23 are arranged, as can be seen for example in FIG. 1.

In this way it is ensured that the locking element 9 can be pushed into the contact support 2 in a correct insertion position, that is to say through the clearance 22 and the opening 21 into the contact support 2, and can fix there by its locking portion 44 a contact 3 at its peripheral latching groove 33.

The locking elements 4 are preferably all formed with different coding ribs 43 and, in an equivalent manner, the openings 21 or else the clearances 22, or in a general manner the contact supports 2, are formed with corresponding coding grooves 23.

As already described, the contact support has abutting means 24, on which the contact 3 pushed into the contact chamber 5 is supported or bears with its contact abutting means 50.

The locking element 4 shown in FIG. 4 is advantageously formed with a semicircular clearance 91, the radius of the semicircular clearance 41 being made to match the radius of the peripheral latching groove 33 of a contact, and thus being able to embrace the contact semicircularly in a positively engaging manner.

It can be seen from FIG. 2 that the locking element 4, as represented in FIG. 4, is provided with a semicircular head portion 45, which is adapted to the radius of curvature of the contact support 2.

This allows the locking element 4 to be pushed flush into the contact support 2 or into the opening 21 and the clearances 22 formed in a way corresponding to the head portion 45. This in turn ensures further redundancy and reliability that the plug connector can only be inserted into the corresponding mating connector in its intended form of assembly.

In a particularly preferred embodiment, the contacts 3 are formed as contacts that are sealed off with respect to the exterior, which is ensured by a peripheral sealing groove 34, in which a sealing ring 35 is integrally formed. The sealing ring 35 abuts the inner side of the contact chamber 5 in a sealing manner, and so the connecting portion 31 of the contact and the portion of the contact chamber 5 receiving said connecting portion is sealed off with respect to the exterior.

In this way, the plug connector according to the invention can be formed as a sealed plug connector without complex sealing measures.

The contact portion 30 of a contact 3 is preferably enclosed by a contact support portion 25 protruding from the contact support 2 and thereby spatially separates the contacts 3 from one another, in that a wall of the contact support 2 is respectively formed between the contact portions 30 in order to form the air gaps and creepage distances in a suitable way in keeping with their use.

Combinations and alternative embodiments of the elements described above of the plug connector 1 according to the invention are likewise considered to be likewise disclosed. The same applies to developments familiar to a person skilled in the art that arise from features of the drawings.

### LIST OF DESIGNATIONS

### Plug Connector with Contact Latching Means

1 plug connector

2 contact support

3 contacts

4 locking element

5 contact chamber

20 contact chamber outer wall

21 openings

22 clearances

23 coding groove

24 abutting means

25 contact support portion

30 contacting portion

31 connecting portion

32 holding portion

33 peripheral latching groove

34 peripheral sealing groove

35 sealing ring

40 plate-like portion

41 semicircular clearance

42 plug-side end

43 coding rib

44 locking portion

45 head portion

50 contact abutting means

1. A plug connector comprising:
A) a contact support with at least one or more contact chambers for receiving a contact;
B) at least one electrical contact;
C) a lateral opening on each side in the contact support, connected in each case with one of the contact chambers;
D) at least one locking element, which can be introduced into the opening in a locking manner in such a way that a locking portion of the locking element arrests or blocks the contact in the contact chamber at a corresponding locking portion.

2. The plug connector as claimed in claim 1, wherein the openings are formed in lateral clearances in the contact support.

3. The plug connector as claimed in claim 1, wherein the openings are formed as substantially flat slits in the contact support, and the flat slits represent a preferably lateral connection between the contact chamber and the outside.

4. The plug connector as claimed in 1, wherein each locking element is of such a form that it can be inserted into the contact support through a clearance and an opening in such a way that it finishes flush with the outer wall of the plug connector and thereby arrests a contact in the contact chamber with its locking portion.

5. The plug connector as claimed in 1, wherein the locking elements respectively have a coding rib

6. The plug connector as claimed in claim 5, wherein the clearances and/or openings are formed with a coding groove corresponding to the locking element.

7. The plug connector as claimed in 1, wherein the contacts have as a locking portion a peripheral latching groove for the engagement of the locking portion of the locking elements.

8. The plug connector as claimed in 1, wherein, with the contacts respectively fitted in the contact chamber, the position of each latching groove of each contact is arranged in relation to its neighboring opening in such a way that the locking element engages with its locking portion in the latching groove if the corresponding locking means has been pushed completely into the equivalent opening.

9. The plug connector as claimed in claim 8, wherein the position of the latching groove of a fitted contact is positioned in the extension of the opening in the contact chamber.

10. The plug connector as claimed in 1, wherein the locking portion is formed at the plug-side end of a locking element.

11. The plug connector as claimed in one or more of the 1, characterized in that wherein the plug-side end is formed as a locking portion with a semicircular clearance.

12. The plug connector as claimed in 1, wherein the contacts have a peripheral sealing groove with a sealing ring , which, with the contacts fitted, seals off the contact chamber with respect to the plugging face of the plug connector.

13. The plug connector as claimed in 1, wherein the locking elements are of such a form that they finish flush with the contact support outer side, as long as the locking elements have been pushed completely into the contact support or the openings in the intended way.

14. The plug connector in as claimed in 1, wherein the locking element fixes the contact axially in or counter to the plugging direction of the plug connector.

15. The plug connector as claimed in 1, wherein the locking element fixes the contact radially in or counter to the plugging direction of the plug connector.
